(19) United States
(12) Patent Application Publication
(10) Pub. No.: US 2013/0108779 A1
(43) Pub. Date: May 2, 2013

(54) Methods of Filling Voids in Copper Structures

(71) Applicants: Torsten Huisinga, Dresden (DE); Jens Hahn, Dresden (DE)

(72) Inventors: Torsten Huisinga, Dresden (DE); Jens Hahn, Dresden (DE)

(73) Assignee: GLOBALFOUNDRIES INC., Grand Cayman (KY)

(21) Appl. No.: 13/285,380

(22) Filed: Oct. 31, 2011

(51) Int. Cl. B05D 5/12

(52) U.S. Cl. 427/97.1

(57) ABSTRACT

Disclosed herein are various methods of filing voids in copper conductive structures on integrated circuit devices. In one example, the method includes the steps of forming a conductive copper structure in a layer of insulating material and performing an electroless deposition process to selectively form a fill layer comprised of a conductive material on the copper containing structure, the fill layer being adapted to at least partially fill any voids that may exist in the conductive copper structure.

### BACKGROUND OF THE INVENTION

1. Field of the Invention

Generally, the present disclosure relates to the manufacturing of sophisticated semiconductor devices, and, more specifically, to various methods of filing voids in copper conductive structures on integrated circuit devices.

2. Description of the Related Art

The fabrication of advanced integrated circuits, such as CPU's, storage devices, ASIC's (application specific integrated circuits) and the like, requires the formation of a large number of field effect transistors (NMOS and PMOS transistors) that substantially determine performance of the integrated circuits. Device designers are under constant pressure to increase the operating speed and electrical performance of transistors and integrated circuit products that employ such transistors. Thus, in modern ultra-high density integrated circuits, device features, like the channel length, have been steadily decreased in size to enhance the performance of the transistors and the overall functionality of the circuit. Given that the channel length (the distance between the source and drain regions) on modern transistor devices may be approximately 30-50 nm, and that further scaling is anticipated in the future, device designers have employed a variety of additional techniques in an effort to improve device performance, e.g., the use of high-k dielectrics, the use of highly-conductive copper lines and vias to provide electrical wiring connections to the transistors, the use metal gate electrode structures, the incorporation of work function metals in the gate electrode structure and the use of channel stress engineering techniques on transistors (create a tensile stress in the channel region for NMOS transistors and create a compressive stress in the channel region for PMOS transistors).

However, the ongoing shrinkage of feature sizes on transistor devices causes certain problems that may at least partially offset the advantages that may be obtained by reduction of the device features. Generally, as the device dimensions have decreased, the physical size of the conductive interconnections, e.g., metal lines and metal vias formed in multiple metallization layers about the device level, have also become smaller. Accordingly, the electrical resistance of conductive interconnections becomes a significant issue in the design of the overall product. Moreover, the reduction in size of the conductive interconnections makes it more difficult to manufacture copper conductive lines and vias without introducing an unacceptable level of voids in the resulting structure.

FIGS. 1A-1D depict various illustrative examples of copper conductive structures, e.g., copper lines and vias that may be formed using prior art techniques. FIG. 1A depicts an illustrative example of a copper conductive line 100 that is formed without any voids. As shown therein, the copper conductive line 100 is formed in a layer of insulating material 10, such as a layer of silicon dioxide or a low-k insulating material (k value less than 3). Also depicted in FIG. 1A is an illustrative layer 12 that acts to passivate a underlying conductive line (not shown) formed below the metallization layer depicted in FIG. 1A. The layer 12 may also perform other functions such as acting as a stop layer for a chemical mechanical polishing (CMP) operation performed on the underlying metallization level. Also depicted in FIG. 1A is a first barrier layer 14, a second barrier layer 16, a copper seed layer 18 and a bulk copper region 20.

One illustrative example of the methods employed to form the copper conductive line 100 depicted in FIG. 1A will now be described. Initially, an opening or trench 11 is etched into the layer of insulating material 10 using known photolithography and etching techniques. Thereafter the barrier layer 14, 16 are conformably deposited in the opening 11 by performing, for example, a conformal plasma-enhanced physical vapor deposition (PEPVD) process. The barrier layers 14, 16 may be comprised of a variety of different materials and the thickness of such layers may vary. In one illustrative embodiment, the barrier layers 14, 16 are comprised of tantalum nitride (TaN) and tantalum (Ta), respectively, and they each may have a thickness of about 1-5 nm. The copper seed layer 18 may then be blanked deposited above the layer of insulating material 10 and in the opening 11 by performing a conformal PEPVD process. The copper seed layer 18 may have a thickness that ranges from about 1-5 nm. Thereafter, in one embodiment, a well-known electroplating process is performed to deposit bulk copper material in the opening 11 and across the device. In general, a voltage is applied to the copper seed layer such that it attracts copper ions that are in the plating solution. After the bulk copper is deposited, a CMP process is performed to remove the excess material positioned outside of the opening 11. This results in the idealized, void-free copper conductive line 100 depicted in FIG. 1A. It should be noted that, although the copper seed layer 18 is depicted in FIG. 1A as being separately identifiable from the bulk copper region 20, in practice the copper seed layer 18 becomes part of the bulk copper region 20 during the electroplating process. The separate depiction of the copper seed layer 18 is only provided for explanation purposes. After the copper plating process is completed a post-plating anneal process is typically performed at a temperature that may range from 80-350° C.

However, given the small size of conductive lines and via on modern semiconductor devices, it is sometimes difficult to manufacture such conductive structures without forming voids in the final structure. Problems such as misalignment due to photolithography errors, undersized openings 11 due to etching problems and incomplete cleaning operations all may lead to the formation of voids in the final conductive structures. FIGS. 1B-1D depict examples of such voids that may be present in such conductive structures that have been manufactured using prior art techniques. For example, FIG. 1B depicts an illustrative example wherein a schematically depicted void 22 is formed entirely within the bulk copper region 20. FIG. 1C depicts an illustrative void 22A that starts in the inner barrier layer 16, e.g., the tantalum layer, and extends into the bulk copper region 20. FIG. 1D depicts an illustrative void 22B that starts in the outer barrier layer 14. e.g., the tantalum nitride layer, and extends into the bulk copper region 20. During then post-anneal process, relative small voids may combine to create relative larger voids, which if large enough and/or properly located can at least reduce the performance capability of the conductive structure and, in a worst case scenario, result in device failure. Moreover, copper conductive structures have a well-known tendency to migrate over time during use of the integrated circuit device—that is at least one reason why the barrier layers 14, 16 are formed—to reduce or prevent such undesirable migration. If such copper migration is not controlled, the copper migration may cause problem such as establishing an electrical short to an adjacent conductive line (not shown). To the extent a void is positioned such that it breaks through or weakens the integrity of the barrier layer 16 and/or the barrier layer 14, the chances of undesirable copper migration is even greater.

The present disclosure is directed to various methods that may avoid, or at least reduce, the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure is directed to various methods of forming copper conductive structures on integrated circuit devices. In one example, the method includes the steps of forming a conductive copper structure in a layer of insulating material and performing an electroless deposition to selectively form a fill layer comprised of a conductive material on the copper containing structure, the fill layer being adapted to at least partially fill any voids that may exist in the conductive copper structure.

In another illustrative example, a method disclosed herein includes the steps of forming a conductive copper structure in a layer of insulating material, performing an anneal process at a temperature within the range of 80-350° C. on the conductive copper structure and, after performing the anneal process, performing an electroless deposition process to selectively form a fill layer comprised of a conductive material on the copper containing structure, wherein the fill layer has a thickness in the range of 2-10 nm and wherein the fill layer is adapted to at least partially fill any voids that may exist in the conductive copper structure.

### BRIEF DESCRIPTION OF THE DRAWINGS

The disclosure may be understood by reference to the following description taken in conjunction with the accompanying drawings, in which like reference numerals identify like elements, and in which:

FIGS. 1A-1D depict one illustrative prior art process flow for forming copper conductive structures on a semiconductor device; and

FIGS. 2A-2C depict various illustrative methods of filing voids in copper conductive structures on integrated circuit devices as disclosed herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

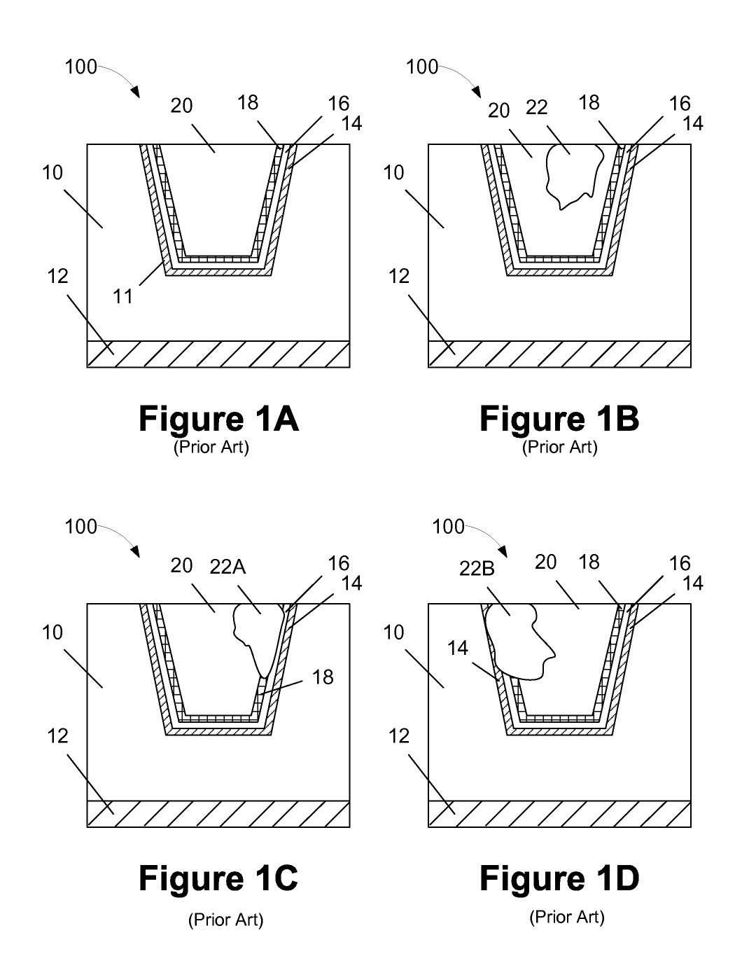

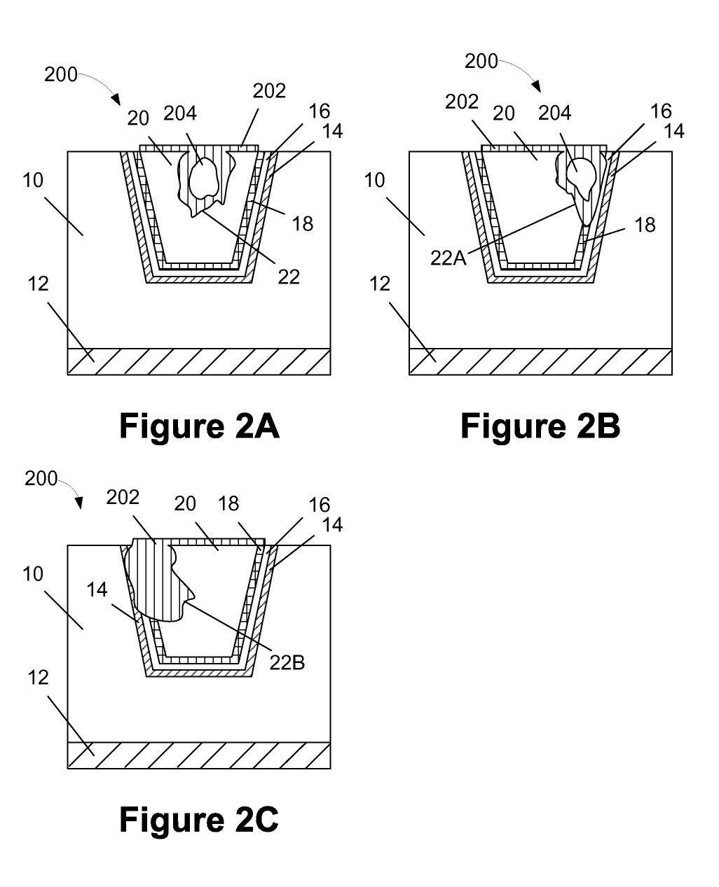

The present disclosure is directed to various methods of forming filing voids in copper conductive structures on integrated circuit devices. As will be readily apparent to those skilled in the art upon a complete reading of the present application, the present method is applicable to a variety of technologies, e.g., NMOS, PMOS, CMOS, etc., and is readily applicable to a variety of devices, including, but not limited to, logic devices, memory devices, etc. With reference to FIGS. 2A-2C, various illustrative embodiments of the methods disclosed herein will now be described in more detail. To the extent that FIGS. 2A-2C use the same reference numbers that have previously been used in connection with FIGS. 1A-1D to describe various structures and regions, those same descriptions apply equally with respect to the corresponding structures and features depicted in FIGS. 2A-2C.

FIGS. 2A-2C depict various illustrative examples of copper conductive structures 200, e.g., copper lines and vias that may be formed using the novel methods disclosed herein. In general, the present disclosure involves, among other things, selectively forming a layer of conductive material on the conductive copper structure 200 so as to at least partially fill any existing voids that may be present in the conductive copper structure 200. More specifically, FIGS. 2A-2C depict the formation of a fill layer 202 that at least partially fill the voids 22, 22A and 22B depicted therein. After the fill layer 202 is formed, the conductive copper structure 200 may or may not have remaining voids 204. For example, FIGS. 2A-2B depict the situation where voids 204 are present after the formation of the fill layer 202, whereas FIG. 2C depicts the situation where there is an absence of voids in the conductive copper structure 200 after the fill layer 202 is formed, i.e., the fill layer 202 substantially fills the initial void 22B.

The fill layer 202 may be formed by performing a selective formation process, i.e., a non-blanket deposition process, to selectively form a conductive material on the copper containing structure 200. For example, an electroless plating or a selective deposition process may be performed so at to selectively form cobalt on, for example, copper, tantalum, or tantalum nitride, or combinations thereof. In one illustrative embodiment, the fill layer 202 may be comprised of a variety of materials such as a cobalt-tungsten-phosphorus (CoWP) material wherein the cobalt will act to inhibit the migration of copper from the conductive copper structure 200. The thickness of the fill layer 202 on the flat upper surface of the bulk copper region 20 may range from approximately 2-10 nm. In one example, the fill layer 202 may be formed at any time after performing the basic post-anneal process, e.g., at a temperature of 80-350° C., on the conductive copper structure 200.

The techniques described herein may help to at least reduce or perhaps eliminate one or more of the problems identified in the background section of the application. For example, in the case where the fill layer 202 comprises a barrier metal, the fill layer 202 may act to restrain undesirable copper migration. The fill layer 202 may also act to further prevent the increase in the size of the voids within the conductive structure. In the case where the void has degraded or destroyed part of the barrier layer 14 and/or the barrier layer 16, the fill layer 202 may act to restore the functionality of the lost barrier material, thereby reducing the chance of undesirable copper migration.

The basic components of the conductive copper structure 200 may be formed in a manner similar to those corresponding structures and layers depicted for the copper conductive line 100 shown in FIG. 1A. That is, the conductive copper structure 200 may be formed in a layer of insulating material 10, such as a layer of silicon dioxide or a low-k insulating material (k value less than 3). Also depicted in FIGS. 2A-2C is an illustrative layer 12 that acts to passivate a underlying conductive line (not shown) formed below the metallization layer depicted in FIGS. 2A-2C. The layer 12 may also perform other functions such as acting as a stop layer for a chemical mechanical polishing (CMP) operation performed on the underlying metallization level. In one illustrative embodiment, the layer 12 may be a layer of silicon nitride, NBLOCK, etc., and it may have a thickness of about 30-40 nm. Also depicted in FIGS. 2A-2C are an illustrative first barrier layer 14, a second barrier layer 16, a copper seed layer 18 and a bulk copper region 20.

In forming the conductive copper structure 200, an opening or trench 11 is etched into the layer of insulating material 10 using known photolithography and etching techniques. Thereafter the barrier layer 14, 16 are conformably deposited in the opening 11 by performing, for example, a conformal plasma-enhanced physical vapor deposition (PEPVD) process. The barrier layers 14, 16 may be comprised of a variety of different materials and the thickness of such layers may vary. In one illustrative embodiment, the barrier layers 14, 16 are comprised of tantalum nitride (TaN) and tantalum (Ta), respectively, and they each may have a thickness of about 1-5 nm. The copper seed layer 18 may then be blanked deposited above the layer of insulating material 10 and in the opening 11 by performing a conformal PEPVD process. The copper seed layer 18 may have a thickness that ranges from about 1-5 nm. Thereafter, in one embodiment, a well-known electroplating process is performed to deposit bulk copper material 20 in the opening 11 and across the device. In general, during the electroplating process, a voltage is applied to the copper seed layer 18 such that it attracts copper ions that are in the copper plating solution. After the bulk copper is deposited, a CMP process is performed to remove the excess material positioned outside of the opening 11. It should be noted that, although the copper seed layer 18 is depicted in FIGS. 2A-2C as being separately identifiable from the bulk copper region 20, in practice the copper seed layer 18 becomes part of the bulk copper region 20 during the electroplating process. The separate depiction of the copper seed layer 18 is only provided for explanation purposes. After the copper plating process is completed a post-plating anneal process is typically performed at a temperature that may range from 80-350° C.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
forming a conductive copper structure in a layer of insulating material, said conductive copper structure comprising at least one void region formed therein; and
performing an electroless deposition process to selectively form a fill layer comprised of a conductive material on said copper containing structure, said fill layer at least partially filling said at least one void region in said conductive copper structure.

2. The method of claim 1, further comprising, prior to performing said electroless deposition process, performing an anneal process at a temperature within the range of 80-350° C.

3. The method of claim 1, wherein said conductive copper structure further comprises at least one layer of tantalum or tantalum nitride.

4. The method of claim 1, wherein said fill layer is comprised of cobalt.

5. The method of claim 4, wherein said fill layer further comprises tungsten and phosphorous.

6. The method of claim 1, wherein said fill layer has a thickness of about 2-10 nm.

7. A method, comprising:
forming a conductive copper structure in a layer of insulating material, said conductive copper structure comprising at least one void region formed therein;
performing an anneal process on said conductive copper structure; and
after performing said anneal process, performing an electroless deposition process to selectively form a fill layer comprised of a conductive material on said copper containing structure, said fill layer having a thickness in the range of 2-10 nm and at least partially filling said at least one void region in said conductive copper structure.

8. The method of claim 7, wherein said anneal process is performed at a temperature within the range of 80-350° C.

9. The method of claim 7, wherein said fill layer is comprised of copper.

10. The method of claim 9, wherein said fill layer further comprises tungsten and phosphorous.

11. A method, comprising:
forming a conductive copper structure in a layer of insulating material;
performing an anneal process at a temperature within the range of 80-350° C. on said conductive copper structure; and
after performing said anneal process, performing an electroless deposition process to selectively form a fill layer comprised of cobalt, tungsten and phosphorous on said copper containing structure, said fill layer having a thickness in the range of 2-10 nm and at least partially filling a void region that is positioned in said conductive copper structure, at least a portion of said void region extending below an upper surface of said conductive copper structure.

12. The method of claim 11, wherein forming said conductive copper structure comprises forming a trench in said layer of insulating material forming at least one barrier material layer in said trench, and forming said conductive copper structure above said at least one barrier material layer, said void region extending into said at least one barrier material layer.

13. The method of claim 1, wherein at least a portion of said at least one void region extends below an upper surface of said conductive copper structure.

14. The method of claim 1, wherein said at least one void region extends into a layer of barrier material formed between said copper conductive structure and said layer of insulating material.

15. The method of claim 7, wherein at least a portion of said at least one void region extends below an upper surface of said conductive copper structure.

16. The method of claim 1, wherein said at least one void region extends into a layer of barrier material formed between said copper conductive structure and said layer of insulating material.
